(19) United States
(12) Patent Application Publication
(10) Pub. No.: US 2017/0072343 A1
(43) Pub. Date: Mar. 16, 2017

(54) Low Back Pressure Self Cleaning Filter

(71) Applicant: Sunglory Inc., Great Neck, NY (US)

(72) Inventors: Xueliang CAO, Great Neck, NY (US); Ximei CAO, Great Neck, NY (US); Jingri SHI, Great Neck, NY (US)

(21) Appl. No.: 14/856,128

(22) Filed: Sep. 16, 2015

(51) Int. Cl. B01D 29/68; B01D 29/11

(52) U.S. Cl. CPC B01D 29/682; B01D 29/11

(57) ABSTRACT

The present disclosure provides a low back pressure self-cleaning filter. The filter has a housing, a filter element residing inside the housing, a driver motor affixed to the housing, and a transmission shaft rotatably coupled to the driver motor. The filter element is connected to the transmission shaft. A plurality of injection nozzles residing on one side of the filter element and a corresponding number of suction nozzles residing on another side of the filter element. Liquid jets from injection nozzles flush the filter element to wash off debris from the filter element. The debris are removed with the suction nozzles.

### TECHNICAL FIELD

The disclosure is related to liquid filtration technologies for environmental protection, especially for a low back pressure backflushing filter.

### TECHNICAL BACKGROUND

Water is an essential natural resource that human beings depend on. Utilization and treatment of water resource is highly relevant to the human living conditions. A large amount of microorganism, such as zooplankton, algae, bacteria and pathogenic bacteria, exist in natural water bodies, e.g., river, lake or ocean. Particularly, in freshwater, with the rapid development of industry and agriculture as well as changes in the environment, increasing amount of pollutants have been discharged into the natural water body. Eutrophication has become a serious problem.

Industrial waste water, well water, river water, lake water, AC circulating water and ballast water all need to be filtered before discharging to protect the environment and ecosystem. Filtration is an effective method to remove organisms in water. However, algae, especially Scenedesmus, can adhere to organic fragments or other plants along with bacteria and form a gelatinous layer that adsorbs organic matters, easily clogging up the filter screen, which affects the filtration effectiveness or even damages the filter.

All above-mentioned organisms should be removed before the water is used. The most common water treatment method are filtration and sterilization. Filtration physically removes organisms and other large particles in the water using a filter screen. Most sterilization are done by UV treatment. However, remains of the organic matter and particles are left in the water, which necessitates further treatments. In practice, many organisms, Scenedesmus in particular, have a strong toleration to UV and cannot be easily killed by UV. Experimental results demonstrate that UV radiation not only may be ineffective to kill certain algae, on the contrary, it may stimulate their growth. Therefore, it could be very difficult to treat such algae. For reasons set forth above, it may be necessary to use filtration to treatment the water.

Hydraulic fluid are used to transfer the motion and power, lubricating kinematic joints. Clean hydraulic fluid is necessary to a functional hydraulic pressure system. However, metal particles caused by abrasion, rubber particles, and colloidal matters caused by oxidation of hydraulic fluid would accumulate overtime, all those substances will affect the performance of hydraulic pressure system, even causing malfunction. Filtration of hydraulic fluid is also a normal practice to keep hydraulic fluid clean.

Filter of small mesh size would be used to filter algae or other particulate matters larger than 10 μm in size. This may reduce the concentration of algae and lessen the load for subsequent treatment steps. However, filter elements having small meshes are prone to clogging under high flow volume, high flow rate operating conditions and may not function properly without frequent cleaning.

In many cases, backflushing filters may require a back pressure of not less than 1.5 bar. If the back pressure is too low, backflushing may not be effective. However, high back pressure backflushing requires elevated pressure in the fluid system, which increases power consumption and operating cost. In order to solve the above-mentioned problems, the disclosure provides a low back pressure self-cleaning filter.

### SUMMARY

This disclosure provides a low back pressure self-cleaning filter. The filter has a housing, a filter element residing inside the housing, a driver motor affixed to the housing, and a transmission shaft rotatably coupled to the driver motor. The filter element is connected to the transmission shaft. A plurality of injection nozzles residing on one side of the filter element and a corresponding number of suction nozzles residing on another side of the filter element. Water jets from injection nozzles flush the filter element wash off debris from the filter element. The debris are removed with the suction nozzles.

In one embodiment of the current disclosure, each injection nozzle is paired with a suction nozzle by aligning said injection nozzle with said suction nozzle across the filter element so that a fluid ejected from the injection nozzle enters said suction nozzle after passing the filter element. The filter has one to thirty pairs of the injection nozzle and the suction nozzle for each square meter of surface area of the filter element.

The filter element comprises one or more layers of filter screen having a mesh size in a range of 10 μm to 200 μm. The injection nozzles and the suction nozzles are configured to rotate relative to the filter element.

In another embodiment, a time interval between two consecutive backflushes ranges from 1 minute to 60 minutes. In still another embodiment, filtration and backflushing are carried out simultaneously. The backflushing is initiated when a pressure differential between a waste water inlet and a filtrate water outlet is 0.3 MPa or higher.

### BRIEF DESCRIPTION OF THE DRAWINGS

FIG. 1 is the front view of one embodiment of the filter.

FIG. 2 is the side view of the embodiment of filter in FIG. 1 with a cutaway.

FIG. 3 is the side view of a filter that does not have an injection nozzle assembly.

FIG. 4 is the vertical installation view of the filter.

FIG. 5 is a schematic diagram of a backflush mechanism.

FIG. 6 is a schematic diagram of a backflush mechanism without an injection nozzle assembly.

FIG. 7(a) shows an embodiment wherein two rows of injection-suction nozzles are employed along the axial direction of the transmission shaft.

FIG. 7(b) shows an embodiment wherein one row of the injection-suction nozzles are employed along the axial direction of the transmission shaft.

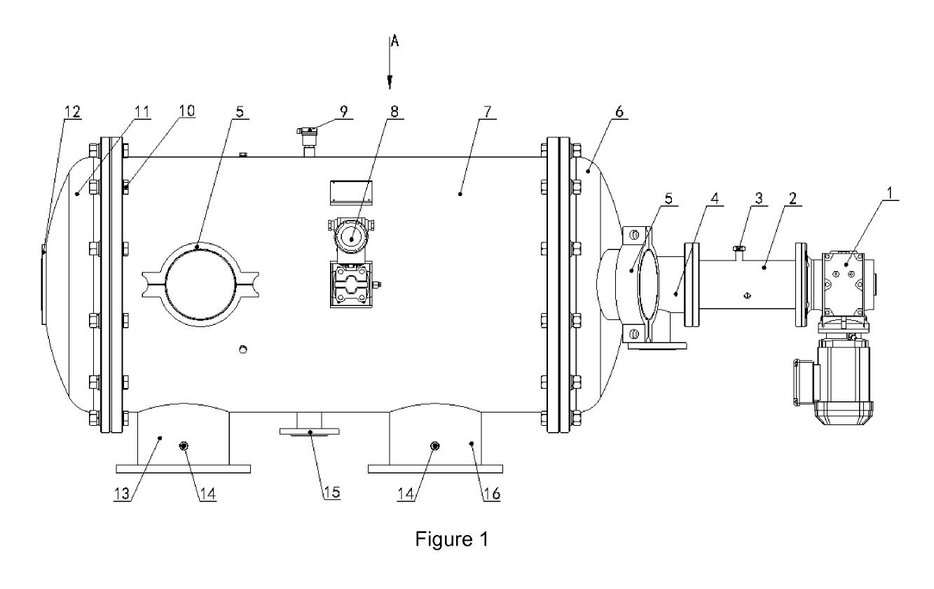

Numerals in the FIGS. 1-3: 1—driver motor, 2—screw sleeve, 3—forward-reserve switch, 4—high pressure water chamber, 5—manhole, 6—head plate, 7—shell, 8—differential pressure (DP) transmitter, 9—vent, 10—bolt, 11—head plate, 12—flange, 13—waste water inlet, 14—pressure gage, 15—washing hole, 16—filtrate water outlet, 17—inlet for high pressure water, 18—drain pipe, 19—enforcement ring, 20—waste water chamber, 21—external injection nozzle, 22—internal suction nozzle, 23—suction tube, 24—filtrate chamber, 25—filter element, 26—high pressure water injection pipe, 27—U clip, 28—drainage chamber, 29—filter element head plate, 30—filter element handle, 31—filtration module spool base, 32—transmission shaft socket, 33—transmission shaft filtrate chamber, 34—transmission shaft base, 35—transmission shaft screw, 36—filter element guide ring, and 37—transmission shaft sleeve.

The transmission shaft assembly includes the drainage chamber (28), the transmission shaft socket (32), the transmission shaft filtrate chamber (33), the transmission shaft base (34), and the transmission screw (35).

The injection nozzle assembly includes the injection nozzles (21), high pressure water injection pipe (26), and the U clip (27). The suction nozzle assembly includes suction nozzle (22) and the suction tube (23). The filtration module includes the filter element (25), the filter element head plate (29), the filter element handle (30), and filtration module spool base (31), and the filter element guide ring (36).

### EMBODIMENTS

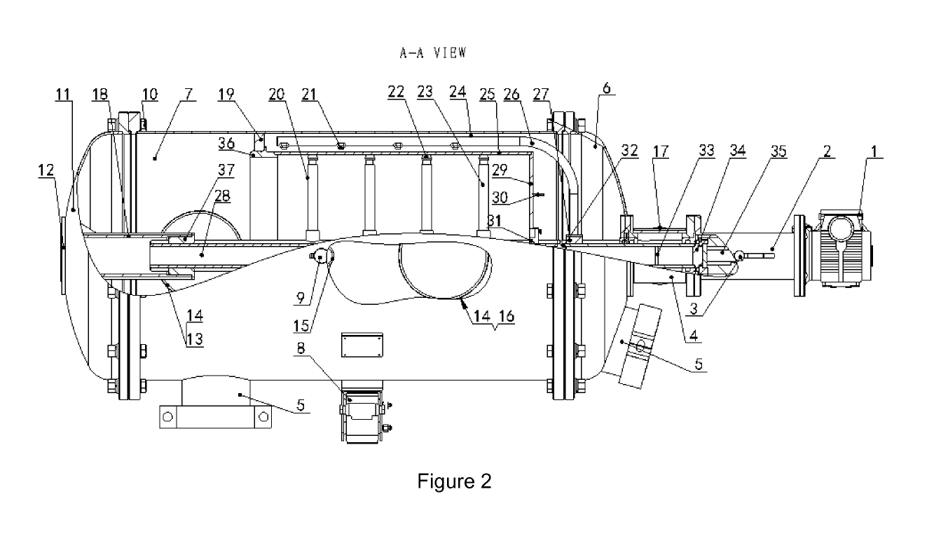

One embodiment of the current disclosure is shown in FIGS. 1, and 2. In this embodiment, the low back pressure self-cleaning filter comprises a shell (7) and two head plates (6, 11), which provide a housing for the filter. Inside the housing an enforcement ring (19) is welded to the inner surface of the shell (7). The enforcement ring (19) strengthens the shell and provides an anchor for the filtration module as well.

The housing also houses a filtration module, which include a filter element (25) with a filter element guide ring (36) on one end and a filter element head plate (29) covering the other end. A handle (30) is installed on the filter element head plate (29). The filter element (25) can be made using a perforated steel screen or a wire mesh screen and be shaped into a cylinder. The filtration module together with the enforcement right (19) divide the interior of the shell into a waste water chamber (20) and a filtrate chamber (24).

The housing also has on it a waste water inlet (13), a filtrate water outlet (16), a manhole (5), a washing hole (15), and a vent (9). During filtration, waste water enters the waste water chamber (20) through waste water inlet (13). The waste water passes through the filter element (25) into the filtrate chamber (24). Particulate matters and other contaminates in the waste water are trapped on the filter element. The filtrate water exits the filter through the filtrate water outlet (16).

Inside the housing there is also a transmission shaft assembly. The transmission shaft has two sections—a drainage chamber (28) and a transmission shaft filtrate chamber (33). The two chambers are separated and fluids in them do not mix. In this embodiment, these two sections are connected at a transmission shaft socket (32). The drainage chamber end of the transmission shaft is coupled with a transmission shaft sleeve (37), which in turn is affixed onto a drain pipe (18). The drain pipe is connected to a flange (12) on the head plate (11), which can be connected to a drain pump (not shown). The filtrate chamber end of the transmission shaft is connected with a transmission screw (35) at a transmission shaft base (35). The transmission shaft filtrate chamber (33) is fluidly connected to a high pressure water chamber (4) disposed about transmission shaft.

Furthermore, a high pressure water injection pipe (26) is connected to the filtrate chamber (33) in the transmission shaft using a pair of U clips (27). A plurality of external injection nozzles (21) (meaning residing on side of the filter element toward the shell) are populated on the high pressure water injection pipe (26). On the other hand, a plurality of internal suction nozzles (23) (meaning residing on the side of filter element away from the shell) are installed on the drainage chamber (28) in the transmission shaft.

During backflushing, a high pressure pump (not shown) draws water from the filtrate chamber (24) through the washing hole (15) and pumped it into the filtrate chamber (33) via the high pressure water inlet (17) and the high pressure water chamber (4). The pressurized water enters the high pressure injection pipe (26) and exits from the plurality of the external injection nozzles (21). Water jets from the injection nozzles (21) wash debris off the filter element. On the other hand, the drain pump (not shown) draws water from the drainage chamber (28), creating a suction force that pulls water and debris from the filter element into the suction nozzles (23). In this manner, debris on the filter element is washed off and removed from the filter.

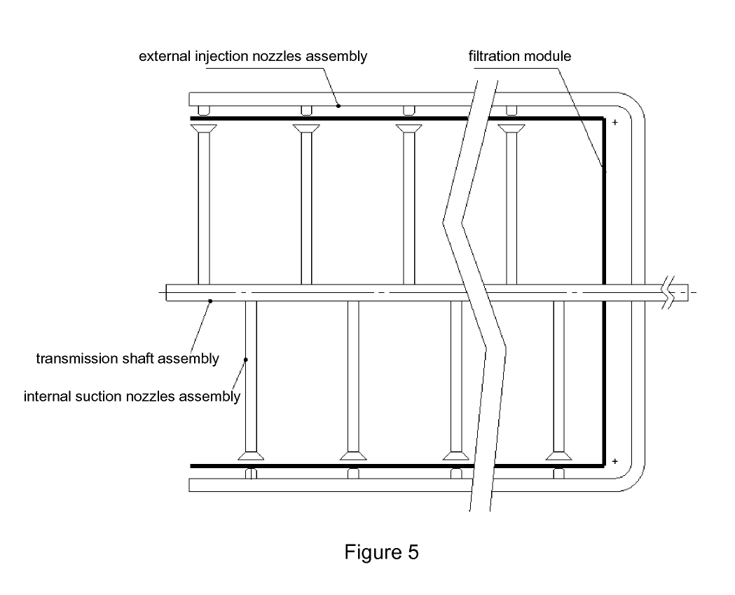

As shown in FIGS. 2, 4, 5, and 7, the injection nozzles (21) and suction nozzles (23) are correspondingly arranged on the opposite side of the filter element (25). For example, each pair of injection nozzle and the suction nozzle are aligned and pointed to each other. The injection nozzle as well as the suction nozzle is installed close to the filter element. For example, the shortest distance from the tip of the nozzle to the filter element can be about 1-10 mm for the injection nozzles and about 0-10 mm for the suction nozzles. In this manner, debris washed off by a water jet from one injection nozzle can be substantially removed from the corresponding suction nozzle.

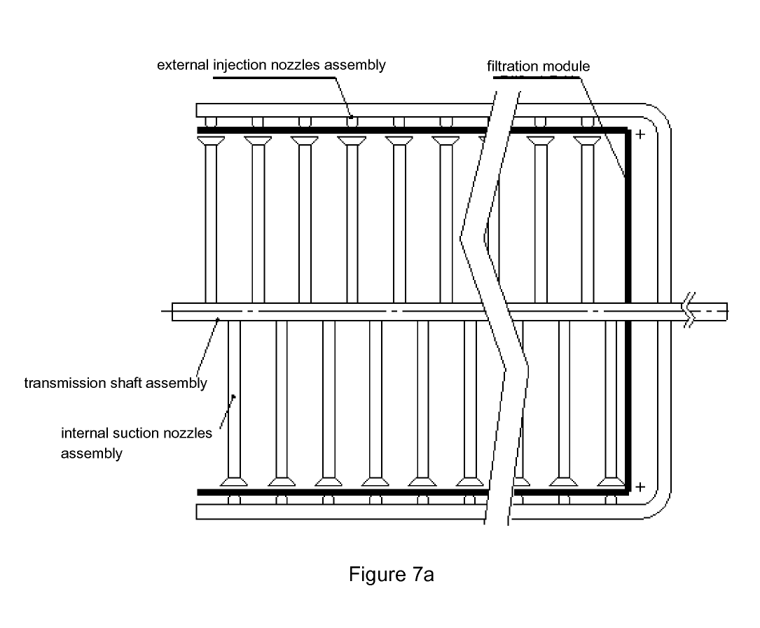

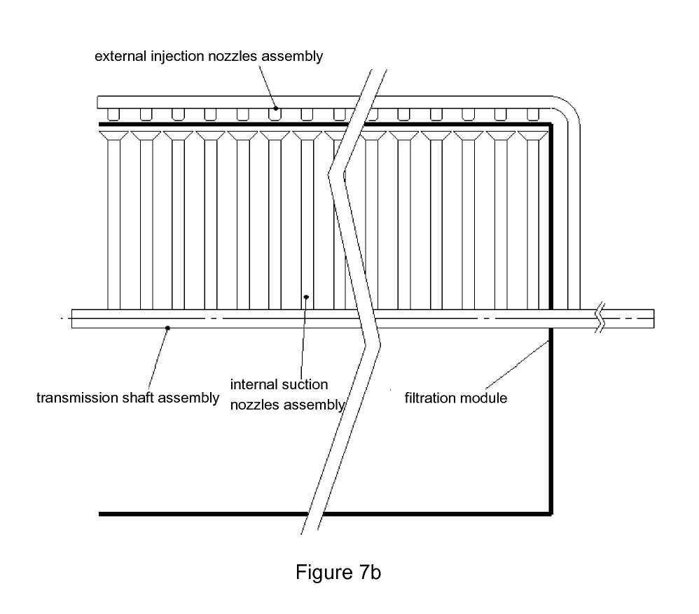

Numbers of the injection nozzles and the suction nozzles and their installation patterns can be adjusted as needed. For example, the filter may have one to thirty pairs of injection nozzles and suction nozzles for each square meters of filtration area, for example, ten to thirty pairs, or ten to twenty pairs. In other examples, filter may have two to twenty four pairs of such nozzles arranged in a row along the axial direction of the transmission shaft. In the peripheral direction, there can be up one to six pairs of nozzles in each circle, meaning there are one to six rows of nozzles along the axial direction. For example, FIG. 7(a) shows an embodiment of the filter having two rows of injection-suction nozzles along the axial direction of the transmission shaft while the embodiment in FIG. 7(b) only has one row.

Furthermore, during backwashing, the driver motor (1) drives the transmission shaft screw (34), which causes the transmission shaft to rotate and to move along the axial direction as well. A forward-reserve switch (3) is installed on the screw sleeve (2). It transmits signals to the control unit (not shown) to control the direction of rotation of the transmission shaft as well as the travel distance of the transmission shaft screw (35). The injection nozzles (21) and the suction nozzles (23) rotate together with the transmission shaft. Since the filter element (25) is stationary and the nozzles rotates as well as travel back and forth along the axial direction of the transmission shaft, the water jets sweep the filter element in spiral patterns, cleaning a large area of the filter element.

In another embodiment of the current disclosure, the transmission shaft screw (35) only has rotational movement but no lateral movement along the axial direction of the transmission shaft. In that case, the forward-reverse switch is not needed and the driver motor (1) only rotates in one direction. The transmission in such an embodiment is simplified accordingly.

In still another embodiment, the suction nozzles are on the shell side of the filter while the injection nozzles are installed opposite to the suction nozzles across from the filter element.

The backflushing operation can be continuous, or initiated at a certain time interval, or triggered when the pressure differential between the water inlet (13) and outlet (16) reaches a certain value. When waste water passes the filter element (25), particulate matters in the water are trapped on the filter element so that the pressure differential between the water inlet (13) and water outlet (16) increases overtime. The DP Transmitter (8) detects that the differential pressure and relays the signal to the control box (not shown). The control box triggers the backflushing operation when the pressure differential reaches a preset value, e.g., any value between 0.3-2 MPa.

When filtering relatively clean water, the filter maybe operated without backflushing for a longer period of time. The backflush may be initiated at regular time intervals according to a preset value in filter control box. The preset value can be anywhere between one (1) minute to sixty (60) min between two backflushes. While filtering dirtier water, when the filter element (25) becomes clogged more quickly, the time interval between two backflush operations can be much shorter, e.g., less than one minute. Indeed, the backflushing can be carried out continuously without stopping.

In one embodiment of the current disclosure, the low back pressure self-cleaning filter was tested and the filtration results are presented in Table 1.

TABLE 1
Test Results on Common Freshwater Algae

| | Microcystis | Closterium | Scenedesmus | Cosmarium | Ankistrodesmus | Pediastrum |
|---|---|---|---|---|---|---|
| Name | sp. | sp. | sp. | sp. | sp. | sp. |
| Before | 3 × 105/L | 1 × 104/L | 6 × 104/L | 8 × 103/L | 7 × 103/L | 5 × 104/L |
| filtration | | | | | | |
| After | 172/L | 22/L | 18/L | 6/L | 78/L | 56/L |
| Filtration | | | | | | |

In another experiment, the inventive filter of the current disclosure was tested when filtering a waste water having a concentration of floating particulates of 200 mg/L for 24 hours. The flow rate of the waste water was in the range of 276-298 m³/hr. The time interval between two consecutive backflushes was 15 minutes. The backflush water consumption was 20-25 m³/hr. The experimental results show that the back pressure of an inventive filter of the current disclosure varied between 0.04-0.15 MPa. The back pressure of 0-0.3 MPa is considered as low back pressure.

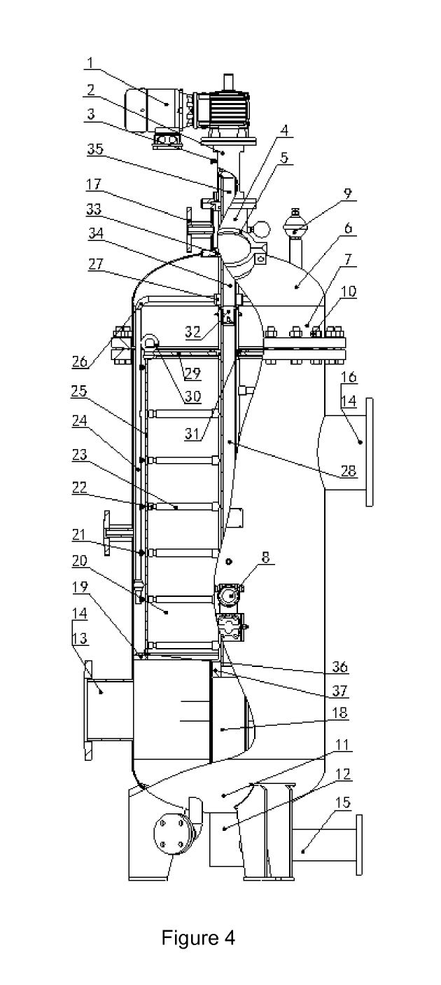

The filter of the current disclosure may be installed either horizontally or vertically (see FIG. 4), depending on worksite specifics and other operational consideration.

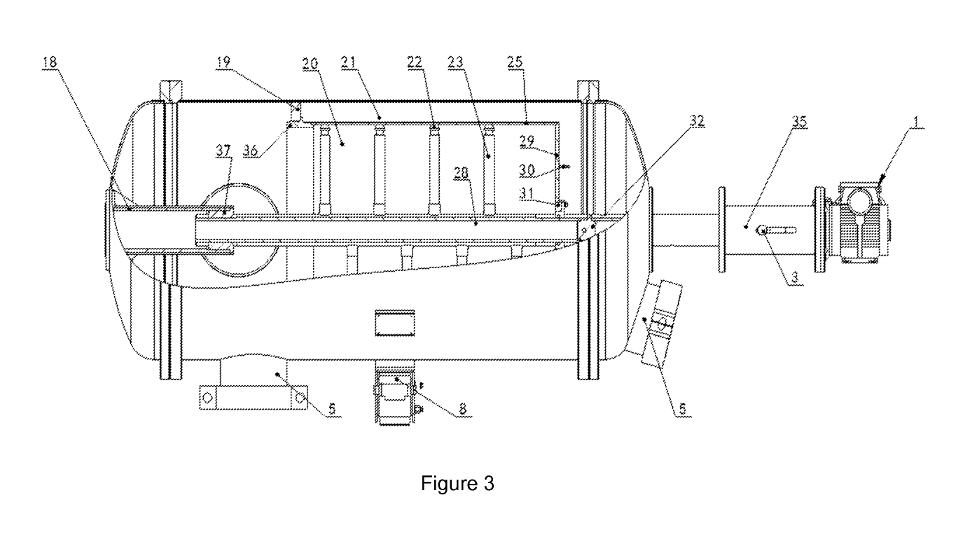

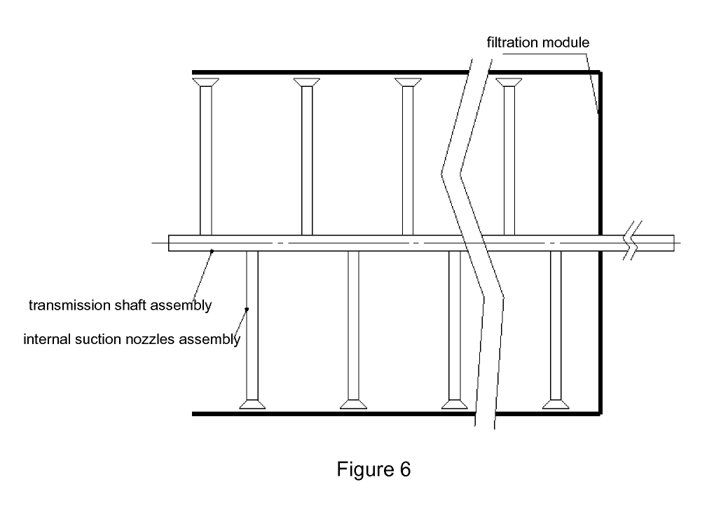

In a comparative example, a comparative filter (see FIGS. 3 and 6) having a plurality of suction nozzles but without corresponding injection nozzles was tested under the same conditions as in the inventive example except that the time interval between two consecutive backflushes was one (1) minute; the backflush water consumption was 45-72 m³/hr and the total flow rate was 248-298 m³/hr. The results show that the back pressure of the comparative filter was in the range of 0.35-0.5 MPa.

Embodiments described above are only for illustrative purposes. One skilled in the art may perform certain modifications or improvements without departing from the scope of the current invention. Such modifications or improvements are within the scope of the current invention.

We claim:

1. A low back pressure self-cleaning filter, comprising:
a housing; a filter element residing inside the housing; a driver motor affixed to the housing; a transmission shaft rotatably coupled to the driver motor; a plurality of injection nozzles residing on a first side of the filter element, wherein each injection nozzle points toward the filter element; and a plurality of suction nozzles residing on a second side of the filter element, wherein each suction nozzle points toward the filter element wherein the filter element is connected to the transmission shaft,
wherein the plurality of injection nozzles and the plurality of suction nozzles are coupled to the transmission shaft.

2. The filter of claim 1, wherein an injection nozzle is paired with a suction nozzle by aligning said injection nozzle with said suction nozzle across the filter element so that a fluid ejected from the injection nozzle enters said suction nozzle after passing the filter element.

3. The filter of claim 2, wherein the filter element is cylindrical in shape.

4. The filter of claim 3, wherein one to six pairs of the injection nozzle and the suction nozzle are provided in the peripheral direction of the filter element and two to twenty four pairs of the injection nozzle and the suction nozzle are provided along the axial direction of the filter element.

5. The filter of claim 2, having one to thirty pairs of the injection nozzle and the suction nozzle for each square meter of surface area of the filter element.

6. The filter of claim 1, the filter element comprises one or more layers of filter screen having a mesh size in a range of 10 μm to 200 μm.

7. The filter of claim 1, a distance between the injection nozzle and the filter element is 1-10 mm and a distance between the suction nozzle and the filter element is 0-10 mm.

8. The filter of claim 1, wherein the injection nozzles and the suction nozzles are configured to rotate relative to the filter element.

9. The filter of claim 1, wherein the filter is installed horizontally or vertically.

10. The filter of claim 1, wherein the transmission shaft rotates and reversibly travels along an axial direction of the transmission shaft.

11. The filter of claim 1, wherein the transmission shaft rotates and does not travel along an axial direction of the transmission shaft.

12. A method to filter a liquid using a filter of claim 1, comprising filtering the liquid and backflushing the filter element, wherein the backflushing further comprises:
injecting a fluid stream from an injection nozzle at the filter element; removing the fluid stream from a suction nozzle located across the filter element from the injection nozzle.

13. The method of claim 12, wherein a time interval between two consecutive backflushing steps ranges from 1 minute to 60 minutes.

14. The method of claim 12, wherein the blackflushing step is continuous.

15. The method of claim 12, wherein the backflushing step occurs simultaneously with the filtering step.

16. The method of claim 12, wherein the backflushing is initiated when a pressure differential between the liquid inlet and a filtrate outlet is 0.3 MPa or higher.

17. The method of claim 12, further comprising rotating the transmission shaft so that the plurality of injection nozzles and the plurality of the suction nozzles rotates with the transmission shaft relative to the filter.

18. The method of claim 12, wherein the liquid is a waste water or a hydraulic fluid.

19. The method of claim 12, wherein the fluid stream from the inject nozzle is a filtrate from the filter.
